(19) United States
(12) Patent Application Publication
(10) Pub. No.: US 2026/0336089 A1
(43) Pub. Date: Oct. 29, 2026

(54) RESERVOIR ARRANGEMENTS FOR HYDRAULIC POWER TOOLS

(71) Applicant: Milwaukee Electric Tool Corporation, Brookfield, WI (US)

(72) Inventors: Harrison T. Snyder, Pewaukee, WI (US); Justin K. Martin, West Bend, WI (US); Mathew R. Rentmeester, Wauwatosa, WI (US); Spencer J. Tiegs, Pewaukee, WI (US)

(21) Appl. No.: 19/663,164

(22) Filed: Apr. 29, 2026

Related U.S. Application Data
(60) Provisional application No. 63/796,553, filed on Apr. 29, 2025.

(51) Int. Cl. B25F 5/00

(52) U.S. Cl. CPC B25F 5/005

(57) ABSTRACT

A power tool includes a motor, a hydraulic actuator, and a pump operated by the motor to supply a fluid to the hydraulic actuator. The pump is positioned between the motor and the hydraulic actuator. A reservoir is disposed over the pump. The reservoir includes a collar at a first end coupled to a first bearing flange of the pump. The reservoir includes a front face at a second end clamped between a second bearing flange of the pump and a manifold of the hydraulic actuator. The reservoir is clamped at both the first end and the second end to seal the pump within the reservoir.

### CROSS-REFERENCE TO RELATED APPLICATIONS

This application claims the benefit of U.S. Provisional Application No. 63/796,553, filed Apr. 29, 2025, which is incorporated herein by reference in its entirety.

### BACKGROUND

The present disclosure relates to systems and methods for reservoir arrangements for hydraulic power tools. Conventional designs typically use rigid cylindrical bladders that seal with external band clamps on both sides of the pump, resulting in a bulky design with multiple components. These arrangements are prone to leaks and increase assembly complexity. There is a growing need for compact and efficient sealing methods in hydraulic tools.

### SUMMARY

According to one aspect of the present disclosure, a power tool is provided. The power tool can include a motor. The power tool can include a hydraulic actuator. The power tool can include a pump operated by the motor to supply a fluid to the hydraulic actuator and positioned between the motor and the hydraulic actuator. The power tool can include a reservoir disposed over the pump. The reservoir can include a collar at a first end coupled to a first bearing flange of the pump and a front face at a second end clamped between a second bearing flange of the pump and a manifold of the hydraulic actuator. The reservoir can be clamped at both the first end and the second end to seal the pump within the reservoir.

In some examples, the power tool can include a clamping interface positioned between the reservoir, the pump, and a gearbox of the motor. The clamping interface can be configured to compress the collar against the first bearing flange.

In some examples, the clamping interface can be a rigid plate defining a plurality of openings configured to receive fasteners that secure the clamping interface to the gearbox.

In some examples, the pump can define a first groove configured to receive a first protrusion of the reservoir.

In some examples, the pump can define a second groove configured to receive a second protrusion of the reservoir.

In some examples, the power tool can include an adapter plate positioned between the pump and the second end of the reservoir. The adapter plate can define a groove configured to receive a protrusion of the reservoir.

In some examples, the front face can be formed from a non-rigid material that elastically deforms under compression to form a seal between the pump and the manifold.

In some examples, the pump and the manifold can contact one another at an interface that limits compression of the front face to a predetermined amount.

In some examples, the power tool can include a face sealing gasket positioned at an interface between the pump and the manifold.

In some examples, the face sealing gasket can be a multi-material crush gasket including a rigid outer diameter and a compliant inner diameter.

In some examples, the face sealing gasket can include an integrated O-ring at the compliant inner diameter.

According to another aspect of the present disclosure, a bladder assembly for a hydraulic power tool is provided. The bladder assembly can include a flexible body configured to contain hydraulic fluid and to be disposed about a pump body of the hydraulic power tool. The bladder assembly can include a collar at a first end of the flexible body. The collar can define a first end opening sized to receive the pump body and configured to be clamped between the pump body and a gearbox to form a first seal. The bladder assembly can include a front face at a second end of the flexible body opposite the first end. The front face can be configured to be clamped between the pump body and a manifold of a hydraulic actuator to form a second seal. The front face can include a first protrusion configured to be received in a first groove defined in the pump body or the manifold.

In some examples, the front face can include a second protrusion configured to be received in a second groove defined in the pump body or the manifold.

In some examples, the front face can be formed from a non-rigid material configured to elastically deform under compression.

In some examples, the bladder assembly can include a face sealing gasket integrated with the front face. The face sealing gasket can include a rigid outer diameter and a compliant inner diameter.

In some examples, the face sealing gasket can include an integrated O-ring.

According to another aspect of the present disclosure, a method of assembling a power tool is provided. The method can include inserting a pump body through a first end opening of a reservoir so that the pump body is disposed within the reservoir. The method can include clamping a collar of the reservoir between a first bearing flange of the pump body and a gearbox to form a first seal. The method can include clamping a front face of the reservoir between a second bearing flange of the pump body and a manifold of a hydraulic actuator to form a second seal. The pump body can be sealed within the reservoir by the first seal and the second seal.

In some examples, the method can include positioning a clamping interface between the reservoir and the gearbox, and securing the clamping interface to the gearbox with fasteners to generate an axial clamping force that compresses the collar against the first bearing flange.

In some examples, clamping the front face can include compressing a protrusion of the reservoir into a groove defined in the pump body or the manifold.

In some examples, the method can include positioning a face sealing gasket at an interface between the pump body and the manifold. The face sealing gasket can include a rigid outer diameter and a compliant inner diameter that deforms under compression to form a fluid-tight seal.

### BRIEF DESCRIPTION OF THE DRAWINGS

The novel features believed characteristic of the illustrative embodiments are set forth in the appended claims. The illustrative embodiments, however, as well as a preferred mode of use, further objectives and descriptions thereof, will best be understood by reference to the following detailed description of one or more illustrative embodiments of the present disclosure when read in conjunction with the accompanying drawings, wherein:

FIG. 1 is an axonometric view of a hydraulic tool, according to aspects of the present disclosure.

FIG. 2 is a diagrammatic view diagram of the hydraulic tool of FIG. 1.

FIG. 3 is an axonometric view of a bladder of the hydraulic tool of FIG. 1, including a sealing interface with the gasket face, opening for bolts, alignment pins, and the pump shaft.

FIG. 4 is an axonometric view of a pump, bladder, and manifold assembly of the hydraulic tool of FIG. 1, where the bladder face is compressed between the pump and the manifold.

FIG. 5 is an axonometric view of the bladder and manifold assembly of FIG. 4.

FIG. 6 is a cross-sectional view of the pump, bladder, and manifold assembly of FIG. 1 taken through line VII-VII of FIG. 4.

FIG. 7 is an exploded view of the pump, bladder, and manifold assembly of FIG. 1.

FIG. 8 is a side view of the pump and manifold assembly of FIG. 4.

FIG. 9 is a cross-sectional view of a pump, bladder, and manifold assembly of the hydraulic tool of FIG. 1.

FIG. 10 is an axonometric view of the pump, bladder, and manifold assembly of FIG. 9, where a clamping plate couples together the bladder and the pump.

FIG. 11 is an axonometric view of the pump and the clamping interface of FIG. 9.

FIG. 12 is an axonometric view of the pump, bladder, and manifold assembly of FIG. 8, where the pump is configured to retain a face sealing gasket.

FIG. 13 is a view of a seal of the bladder of FIG. 12, taken about line VIII-VIII, where the seal is a crush seal with integrated rubber seal.

### DETAILED DESCRIPTION

Hydraulic tools can be used to perform a work function on a workpiece (e.g., a cut, a crimp, a punch). Generally, hydraulic tools can include a pump and piston configuration, where the piston is configured to extend and retract to pump fluid to generate pressure, and thus, move jaws or any other implement coupled to the piston to perform the task. For example, a motor can operate a pump to generate a pressurized flow of hydraulic fluid that is provided from a reservoir (e.g., a bladder, a tank, etc.) to the hydraulic actuator.

According to aspects of the disclosure, a pump can be at least partially disposed within a reservoir (e.g., a bladder, a tank, etc.). Sealing of the reservoir is achieved through a dual-seal configuration that provides distinct advantages over conventional band clamp arrangements. Specifically, a face seal (e.g., a front face of the reservoir) is clamped between a body of the pump and an actuator (e.g., a cylinder) of the power tool. This face seal arrangement differs fundamentally from conventional arrangements wherein a collar of the bladder is secured to the body of the pump or the cylinder via external clamps (e.g., band clamps). By compressing the face of the bladder between the pump body and the actuator, the effective sealing area is substantially increased compared with conventional cylindrical collar seals, while simultaneously reducing the overall tool dimension at the sealing interface. Additionally, the front face of the bladder functions as an integrated gasket, defining precisely positioned openings that permit controlled fluid flow between the pump and cylinder while establishing a robust seal that minimizes leakage at these critical fluid pathway connections.

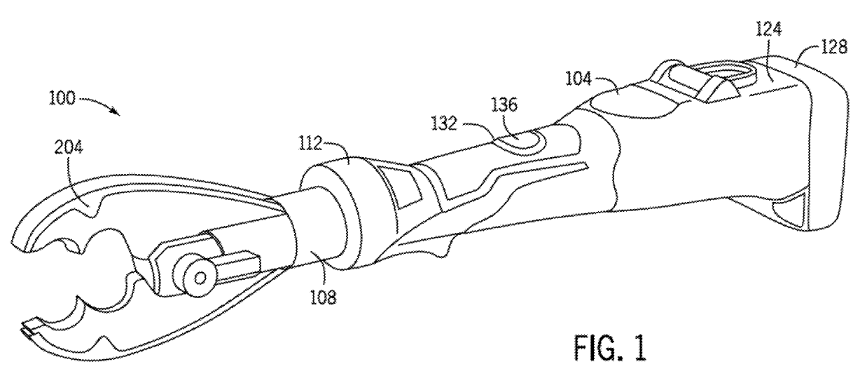

FIGS. 1-5 illustrate an example of a hydraulic tool 100, in accordance with the present disclosure. Although the example implementation described herein references a crimping tool, the features of this disclosure can be implemented in other similar tools, such as cutting tools or punching tools. In addition, any suitable size, shape or type of elements or materials could be used. The illustrated hydraulic tool 100 includes a tool body 104 (e.g., an actuator, a motor, a reservoir, electronics, etc.) and a working head 108. The working head 108 is removably coupled to the tool body 104 to perform an operation on a work piece. The tool body 104 is disposed within a housing 112 and the working head 108 is coupled to the housing 112 to perform an operation on a work piece. In some examples, the working head 108 is configured as a set of jaws 116; however, in other examples, other types of working heads are used. In some examples, the hydraulic tool 100 is battery-operated and the housing 112 defines a battery receptacle 124 that is configured to receive a battery 128. In other examples the hydraulic tool 100 is corded.

To operate the hydraulic tool 100, as seen in FIG. 1, a first user interface 132 (i.e., interface) that is coupled to the housing 112. In some examples, the interface 132 includes a trigger 136 (e.g., button, lever). The trigger 136 can be manipulated to actuate the hydraulic tool 100 and perform the work operation. In some examples, activating the trigger 136 controls the operation of an output assembly 140 that is disposed within the housing 112.

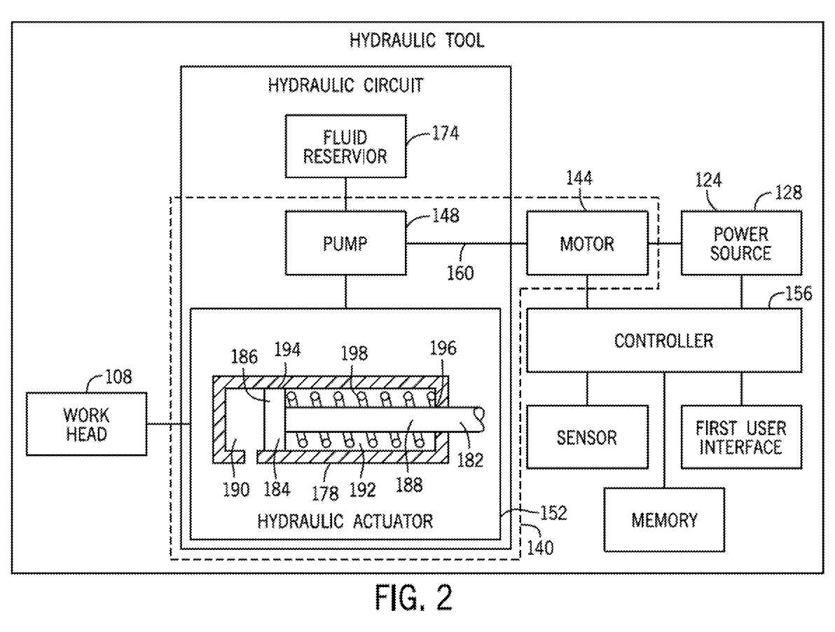

Referring to FIG. 2, the output assembly 140 includes a motor 144, a pump 148, and a hydraulic actuator 152. In some examples, the hydraulic actuator 152 acts on the working head 108 to perform the work operation. When the trigger 136 is actuated, electrical current flows from the battery 128 to the output assembly 140, causing the output assembly 140 to operate the working head 108 to perform the work operation. In some examples, the trigger 136 communicates with an electronic controller 156 that controls a flow of electrical current from the battery 128 or another power source.

In some examples, the electrical current from the battery 128 is provided to the motor 144 of the output assembly 140. In some examples, the motor 144 is coupled to the pump 148 so that rotation of the motor 144 operates the pump 148 to supply pressurized hydraulic fluid to the hydraulic actuator 152. In some cases, the motor 144 is coupled to the pump 148 via a transmission 160 (e.g., a gear reducer).

Still referring to FIG. 2, the hydraulic tool 100 includes the hydraulic actuator 152. The pump 148 supplies hydraulic fluid from a reservoir 174 (e.g., a tank) to a hydraulic cylinder 178 (i.e., cylinder). A ram 182 is movably received in the hydraulic cylinder 178. The ram 182 moves within the cylinder 178 in response to hydraulic fluid being provided from a reservoir 174 to the cylinder 178 by the pump 148 and fluid being drained from the cylinder 178 to the reservoir 174. In general, the ram 182 includes a piston 184 (e.g., a ram or other actuated member) having a piston head 186 and a piston rod 188. The piston 184 is moveably received in the cylinder 178 to form a first chamber 190 and a second chamber 192 within the internal volume of the cylinder 178. A piston seal 194 is provided to seal between the piston head 186 and the cylinder 178 to prevent fluid from leaking between the first chamber 190 and the second chamber 192. A rod seal 196 is provided to seal between the cylinder 178 and the piston rod 188 to prevent hydraulic fluid from leaking out of the cylinder 178. A return mechanism 198 (e.g., spring, hydraulic pressure, etc.) is used to move the piston 184 between positions (e.g., a first or retracted position, and a second or extended position). Depending on the particular type of power tool, the piston 184 may apply force to cause a work operation by moving toward either the extended or retracted position.

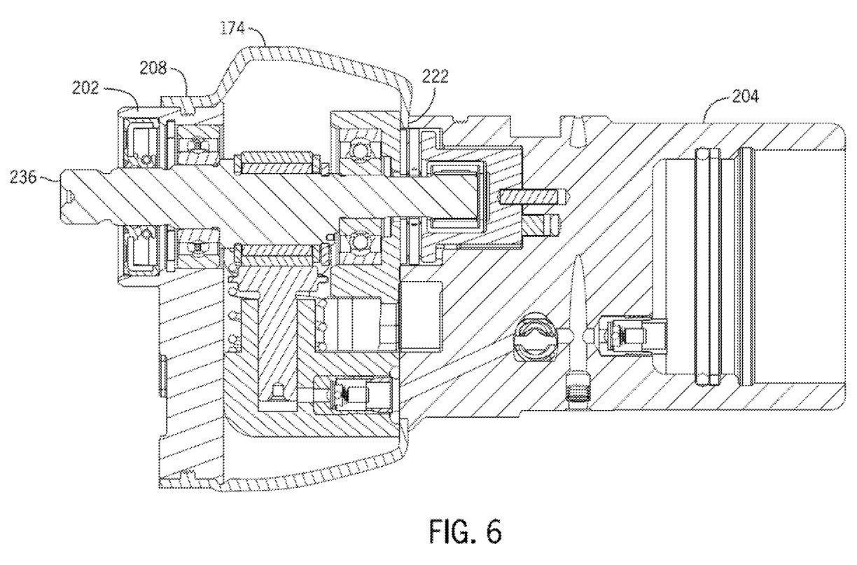

Referring to FIG. 2 and 6, the hydraulic tool 100 includes an actuator assembly that comprises the pump body 202, the manifold 204, and the reservoir 174. The pump body 202 includes a first bearing flange 230 and a second bearing flange 234 that rotatably support the pump shaft 236. The manifold 204 is configured to direct hydraulic fluid to the hydraulic actuator 152. The reservoir 174 is disposed over the pump body 202, and includes a collar portion (e.g., the collar 208) coupled to the first bearing flange 230 and a face portion 222(e.g., front face) clamped between the second bearing flange 234 and the manifold 204. The face portion 222 defines a first opening 252 through which the pump shaft 236 extends.

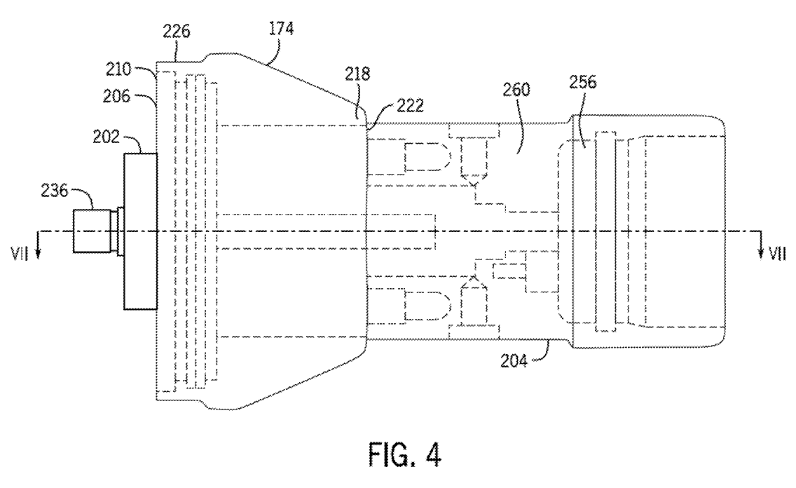

A pump assembly for a hydraulic tool can include a camshaft that is rotated by a motor, which in turn reciprocates a piston to provide pressurized hydraulic fluid to a hydraulic actuator. For example, as seen in FIG. 2-4, the pump 148 includes a pump body 202 that is positioned between the motor 144 and the cylinder 178. In the illustrated example, the pump body 202 is positioned within the reservoir 174. FIG. 4 illustrates an example of the reservoir 174, configured as a flexible and low-pressure reservoir that is coupled to the pump body 202 and a manifold 204. In some examples, the manifold 204 is part of the hydraulic actuator 152 and defines internal channels for hydraulic fluid flow. The reservoir 174 is configured to allow hydraulic fluid to flow between the pump body 202 and the manifold 204 through the internal fluid channels.

The reservoir 174 is configured as a bladder assembly that includes a flexible body configured to contain hydraulic fluid and to be disposed about the pump body 202. The bladder assembly includes a collar 208 at a first end of the flexible body that defines a first end opening 210 sized to receive the pump body 202 and configured to form a collar seal about the pump body 202. The bladder assembly further includes a front face 222 at a second end of the flexible body opposite the first end, the front face 222 defining a first opening 252 configured to allow the pump shaft 236 to extend therethrough. The front face 222 is configured to be clamped between the pump body 202 and the manifold 204 of the hydraulic actuator 152 to form a face seal.

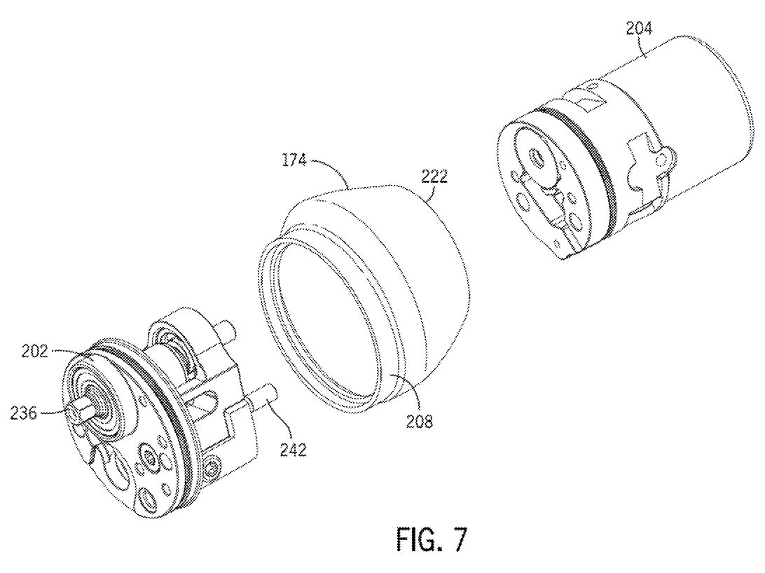

More specifically, as seen in FIG. 6-7, a first end 206 (e.g., a rear end proximate the motor 144) of the reservoir 174 includes a collar 208 that defines a first end opening 210, and a second end 218 (e.g., a front end proximate the hydraulic actuator 152) defines the front face 222 (e.g., a gasket face). As seen in FIG. 4, the first cross-sectional area (taken along a plane normal to the extension axis of the ram 182) at the first end 206 (i.e., at the collar seal) is greater than the second cross-sectional area (taken along a plane normal to the extension axis of the ram 182) at the second end 218 (i.e., at the face seal), which permits insertion of the pump body 202 through the first end opening 210 during assembly of the power tool 100. To establish a sealed interface at the collar 208, the collar 208 is dimensioned to have an inner circumference that corresponds to, and is preferably slightly smaller than, an outer circumference of a first sealing face 226 on the pump body 202, thereby creating an interference fit that generates compressive sealing force upon assembly.

In the illustrated example, and referring to FIGS. 6-7, the first sealing face 226 is a peripheral surface of a first bearing flange 230 that is opposite a second bearing flange 234, with one or more of the bearing flange 230 and the bearing flange 234 facilitating the rotatable support of a pump shaft 236 (e.g., via bearings or bushings positioned in openings of the bearing flanges). In some examples, the collar 208 is dimensioned to be smaller than the first bearing flange 230 such that the collar 208 generates and maintains a continuous compressive force against the first bearing flange 230, which effectuates a reliable seal therebetween without requiring adhesives or additional sealing compounds. In some examples, a clamp 238 (e.g., a band clamp, wire, etc.) is used to supplement the sealing force on the collar 208 and first bearing flange 230. In some examples, the collar 208 or the first bearing flange 230 can include corresponding grooves or protrusions to increase the effective sealing path length or create a tortuous path seal (e.g., a labyrinth seal), which enhances resistance to fluid migration.

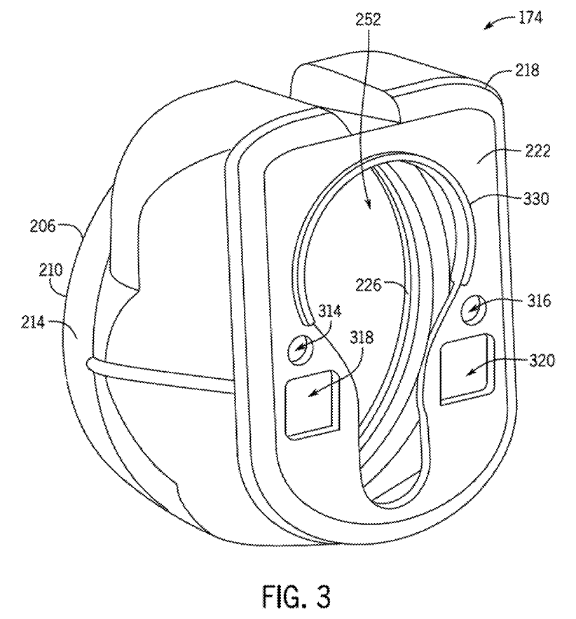

Referring to FIG. 3, correspondingly, the front face 222 provides a face seal interface between the pump body 202 (e.g., at the second bearing flange 234) and the manifold 204 of the hydraulic actuator 152. Unlike conventional cylindrical collar seals that require external clamping bands, the pump body 202 and the manifold 204 are configured to directly apply compressive force to the front face 222, forming a sealed interface through the structural fastening of these components without requiring separate external collar clamps. This configuration reduces component count and assembly complexity while providing a larger, more uniform sealing contact area. The front face 222 is formed as a substantially flat and continuous surface that conforms to corresponding planar mating surfaces on the pump body 202 and manifold 204. In some examples, the front face 222 of the bladder assembly includes protrusions or grooves to increase the effective sealing area or create a tortuous path seal (e.g., a labyrinth seal), as discussed in greater detail below.

In some examples, the front face 222 of the reservoir 174 includes openings to allow fluid to flow between the pump 148, the hydraulic actuator 152, and the reservoir 174. As shown in FIG. 3, the front face 222 can include a first opening 252 or set of openings. The first opening 252 is configured to allow the pump shaft 236 to extend through the front face 222 and form a shear seal assembly at the end of the pump shaft 236. In this way, the pump shaft 236 is coupled to a control valve 256 (e.g., a shear seal valve) that is operated (e.g., rotated, moved) by the pump shaft 236 to control fluid flow between the hydraulic actuator 152 and the pump 148 or reservoir 174.

In some examples, the first opening 252 can have a keyhole-shaped geometry, or another geometry, to allow the first opening 252 to accommodate the pump shaft 236 and other geometrical or functional features of the power tool 100 while providing a sealing interface around the perimeter of the first opening 252. In some examples, a fluid passage 260 is aligned in the first opening 252 to allow fluid flow between the pump 148 and the hydraulic actuator 152.

In some examples, the front face 222 further includes a second set of openings to allow a plurality of fasteners 242 (e.g., bolts, screws, etc.), a plurality of alignment pins 248, and the pump shaft 236 to pass through the front face 222 between the pump body 202 and the hydraulic actuator 152. The second set of openings includes a second opening 314 and a third opening 316 (e.g., a second bolt opening and a third bolt opening). As illustrated in FIG. 3, the second opening 314 and the third opening 316 are in an opposed configuration about and adjacent to the first opening 252. The second opening 314 and the third opening 316 are configured to receive the bolts 242 that secure the reservoir 174 to the manifold 204.

In some examples, the second opening 314 and the third opening 316 are square-shaped apertures configured to allow the bolts 242 to pass through the reservoir 174 and thread into the threaded holes 328 in the manifold 204; in other examples, other shaped apertures are used. Upon insertion through the second opening 314 and the third opening 316, the bolts 242 are tightened to apply compressive force to the front face 222, thereby securing the reservoir 174 and establishing a sealed interface. Advantageously, the compressive force is distributed over a larger sealing area at the front face 222 compared to the collar 208, which increases sealing effectiveness due to the relationship between surface area and unit pressure distribution. In some examples, the sealing effectiveness improvement is further characterized by reduced localized stress concentrations that could otherwise cause seal deformation or failure, more uniform distribution of compressive force across the sealing interface, enhanced seal conformity to mating surface irregularities, and increased seal durability over repeated pressure cycling.

The reservoir 174 further defines a third set of openings to allow alignment features (e.g., pins, protrusions, etc.) to pass through the front face 222 between the pump body 202 and the hydraulic actuator 152. Here, alignment pins 248 extend through alignment pin openings, further configured as a fourth opening 318 and a fifth opening 320 (e.g., fourth alignment pin opening and fifth alignment pin opening) to ensure proper spatial arrangement between the pump body 202, reservoir 174, and manifold 204.

The alignment pins 248 are configured to extend from the pump body 202 and engage with the manifold 204 through the reservoir 174. The alignment pin openings 318 and 320 are positioned adjacent to the first opening 252 to maintain proper orientation of the reservoir 174 during assembly. The alignment pins 248 permit the bolt openings 314, 316 and the first openings 252 to be positioned properly relative to the manifold 204 and the pump body 202. The alignment pins 248 can extend through the alignment pin openings 318 and 320 and into a plurality of corresponding alignment holes 326 in the manifold 204. In some examples, the alignment pins 248 are press-fit into the pump body 202 and slide through the front face 222 during assembly. The alignment pins 248 ensure that the bolt openings 314, 316 are in alignment with the threaded holes 328 of the manifold 204 for assembly.

As mentioned above, in some examples, the front face 222 of the reservoir 174 can include protrusions to facilitate alignment during assembly and enhance sealing performance. For example, the reservoir 174 includes a protrusion 330 (e.g., a seal bead) that extends along the periphery of the first opening 252. In particular, the protrusion 330 extends around the larger portion of the key-hole geometry of the first opening 252. In some examples, the protrusion 330 aids in positioning of the pump shaft 236 while facilitating proper alignment of the reservoir 174 and the manifold 204 during assembly. In the illustrated example of FIG. 3, the protrusion 330 is configured as a raised ridge (e.g., seal bead) that extends outwardly from the front face 222 toward the manifold 204. The seal bead configuration concentrates compressive sealing force along a defined path surrounding the first opening 252, thereby creating a high-integrity seal that resists fluid migration even under varying hydraulic pressures. In some examples, the protrusion 330 forms a continuous, concentric ridge that conforms to the geometry of the first opening 252, increasing the effective contact pressure between the front face 222 and the manifold 204 and preventing lateral movement with respect to the first opening 252, therefore, enhancing sealing performance under dynamic operating conditions. In some examples, other types and configurations of protrusions are used. In other examples, multiple protrusions are provided, or protrusions are provided at different locations or extended by different amounts about an opening to create graduated sealing zones.

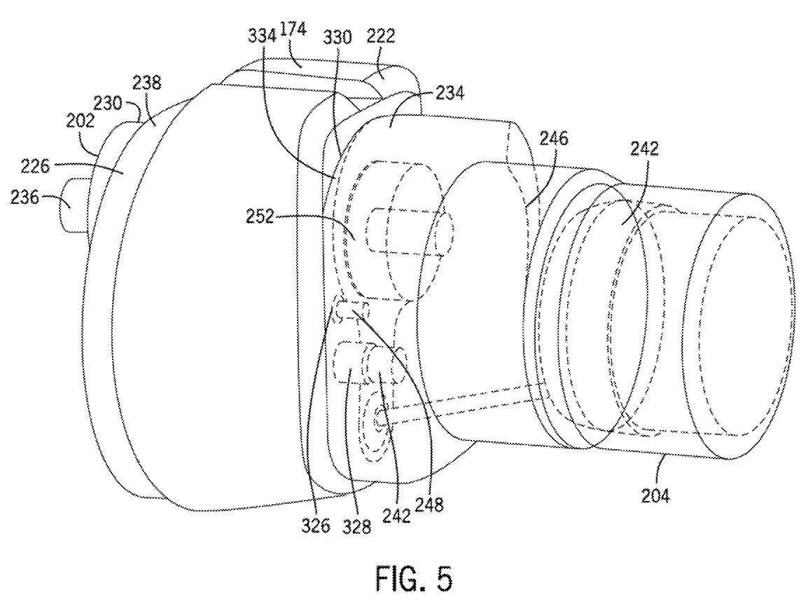

In some examples, as seen in FIGS. 4-5, the manifold 204 defines a groove 334 (e.g., channel) configured to receive the protrusion 330 when the front face 222 is clamped between the pump body 202 and the manifold 204. The groove 334 is defined in a sealing surface of the manifold 204 and is shaped in accordance with the geometry of the protrusion 330 to provide a mating engagement. The engagement between the protrusion 330 and the groove 334 creates an interlocking sealing interface that provides enhanced sealing performance compared to flat-surface seals by forming an additional compression zone where the seal bead is constrained within the groove. This constrained configuration prevents lateral extrusion of the seal material under pressure, maintaining seal integrity during high-pressure operation. In some cases, the protrusion 330 and the groove 334 cooperatively form a tortuous path seal (e.g., a labyrinth seal), which increases the effective sealing path length and thereby reduces the potential for fluid leakage (e.g., preventing hydraulic fluid from escaping around the first opening 252 under operating pressures).

In some examples, the protrusions 330 are replaced with alternative alignment structures (e.g., keyed tabs) with corresponding channels in the manifold 204. Similarly, in some cases, the groove 334 is replaced with alignment slots or other guiding structures that achieve equivalent alignment and sealing functionality.

A method of assembling the power tool 100 includes inserting the pump body 202 through the first end opening 210 of the reservoir 174 so that the pump body 202 is disposed within the reservoir 174. The method further includes coupling the collar 208 of the reservoir 174 to the first bearing flange 230 of the pump body 202 to form a collar seal. The method also includes positioning the front face 222 of the reservoir 174 against the second bearing flange 234 of the pump body 202. The method further includes clamping the front face 222 between the pump body 202 and the manifold 204 of the hydraulic actuator 152 to form a face seal that seals the pump body 202 within the reservoir 174. In some examples, the method includes extending the pump shaft 236 through the first opening 252 in the front face 222. In some examples, clamping includes inserting the fasteners 242 through the fastener openings (e.g., the second opening 314 and third opening 316) in the front face 222 and threading the fasteners 242 into the manifold 204.

The disclosed reservoir arrangement for hydraulic tools provides significant advantages in assembly efficiency and leak prevention. In contrast to conventional sealing arrangements that rely on cylindrical collars secured by external band clamps at both ends of the pump, the disclosed configuration utilizes a large flat surface of the front face 222 to form the primary seal at the actuator interface. This approach results in several technical improvements: (1) reduced component count, as the external clamp at the actuator end is eliminated; (2) reduced overall tool dimension at the sealing location, enabling more compact tool designs; (3) increased sealing surface area compared to cylindrical collar interfaces, resulting in more uniform pressure distribution and improved sealing reliability; and (4) enhanced assembly efficiency, as the face seal is automatically compressed when the pump body and manifold are fastened together, eliminating the separate clamping step required by conventional designs. The flat surface of the front face 222 provides a greater effective sealing surface area than a cylindrical interface of equivalent dimension, which contributes to more robust and durable sealing performance over the service life of the tool.

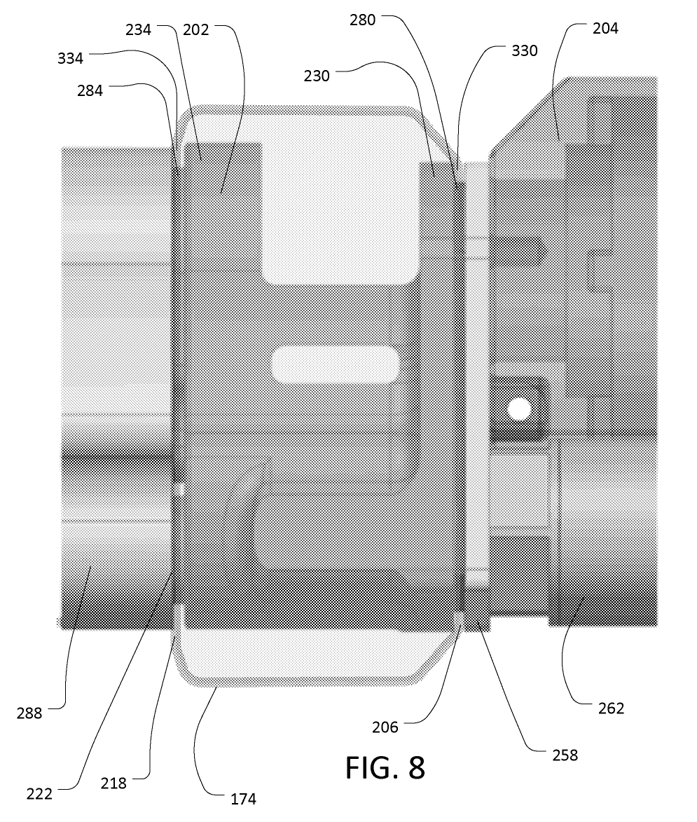

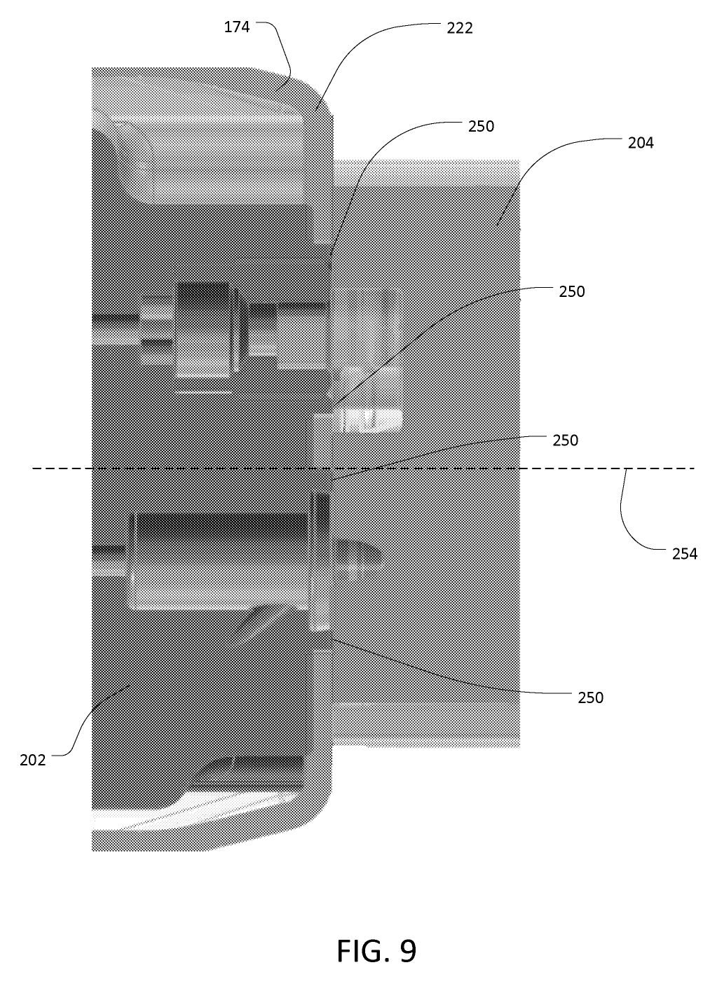

In some examples, other bladder sealing arrangements can be used with the hydraulic tool of FIG. 1. Specifically, a bladder can be sealed to a pump body or manifold without the need for band clamps or other auxiliary fasteners. A dual clamp arrangement can be configured in different ways to provide improved sealing at both ends of the reservoir. For example, the bladder can be clamped at a first end between the pump body and a gearbox or motor housing, and clamped at a second end between the pump body and the manifold of the hydraulic actuator. This dual clamping configuration secures the reservoir at both ends through structural fastening of adjacent components rather than relying on external band clamps. For example, as shown in FIGS. 8-11, the reservoir 174 is configured in a dual clamping arrangement. The reservoir 174 is coupled to the pump body 202 without the use of supplemental sealing elements such as adhesives, sealants, or external clamps.

In the illustrated example in FIGS. 8-11, the reservoir 174 is clamped between the pump body 202 and the manifold 204 at both the first end 206 and the second end 218. At the second end 218, the front face 222 of the reservoir 174 is clamped between the second bearing flange 234 of the pump body 202 and the manifold 204, as described above. At the first end 206, the reservoir 174 is secured to the first bearing flange 230 via a clamping interface 258 that compresses the reservoir 174 between the pump body 202 and the gearbox 262. The dual clamping arrangement may provide enhanced sealing performance by distributing clamping forces at both ends of the reservoir 174.

In some examples, grooves are configured to receive sealing features of a reservoir. Grooves can be arranged in different ways, such as a groove defined in the pump body 202, a groove defined in the manifold 204, or a groove defined in an adapter plate 288 positioned between the pump body 202 and the second end 218 of the reservoir 174. In some examples, the pump body 202 or the manifold 204 define grooves configured to receive the first end 206 or the second end 218 of the reservoir 174. In the illustrated example in FIG. 8, the pump body 202 defines a first groove 280 configured to receive a first protrusion 330 of the reservoir 174 and a second groove 284 configured to receive a second protrusion 334 of the reservoir 174.

In some examples, the first groove 280 or the second groove 284 are sized and shaped to correspond to the geometry of the first protrusion 330 or the second protrusion 334, creating an interlocking engagement that enhances sealing performance. In some examples, the first groove 280 and the second groove 284 receive other types of sealing elements, such as O-rings, gasket beads, or raised ridges formed on the front face 222 of the reservoir 174. In some examples, the first groove 280 and the second groove 284 are positioned at various locations along the interface between the pump body 202 and the manifold 204 to provide multiple sealing zones. In some examples, an adapter plate 288 is positioned between the pump body 202 and the second end 218 of the reservoir 174, and the adapter plate 288 defines the second groove 284 configured to receive corresponding sealing features of the reservoir 174.

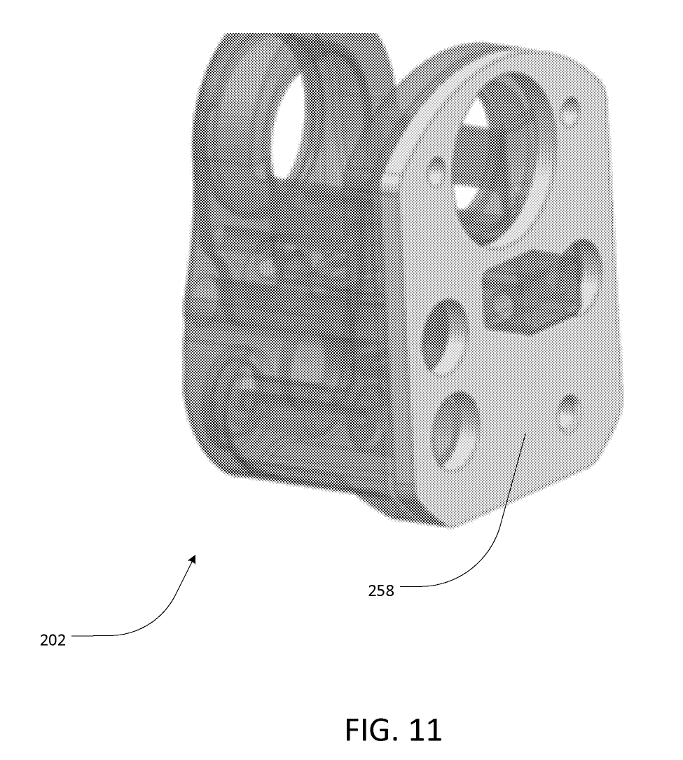

In some examples, a power tool can include an optional mounting or clamping plate to secure components of the hydraulic system. A clamping plate can be arranged in different ways, such as a plate positioned between the pump body and the gearbox, or as a plate positioned between the manifold and the motor housing. For example, as shown in FIG. 11, the clamping interface 258 is configured as a rigid plate, such as a plate formed from plastic, metal, or a composite material. In some examples, the clamping interface 258 is configured as a flat plate. In some examples, other geometries (e.g., contoured or stepped) are used to correspond to mating surfaces of the reservoir 174 and the pump body 202. The clamping interface 258 may include a plurality of openings 264 configured to accommodate mechanical and fluid connections. In some examples, the openings include fastener holes for receiving fasteners that secure the clamping interface 258 to adjacent components, alignment pin holes for maintaining proper positioning during assembly, and fluid passage openings that permit hydraulic fluid to flow between the pump body 202 and the motor 144.

In some examples, the clamping interface 258 functions as an intermediary structural element positioned between the reservoir 174, the pump body 202, and a gearbox 262 (i.e., transducer) of the motor 144. The clamping interface 258 is disposed between the first end 206 of the reservoir 174, the pump body 202, and the gearbox 262. The clamping interface 258 is configured to secure on one side to the manifold 204 and the motor 144, and on the other side to the pump body 202. In some examples, the clamping interface 258 defines a central opening sized 292 to receive a portion of the pump body 202 or to allow a shaft to pass therethrough. In some examples, the clamping interface 258 defines the plurality of openings 264 configured to receive fasteners that extend through the clamping interface 258 and into the gearbox 262 or motor housing.

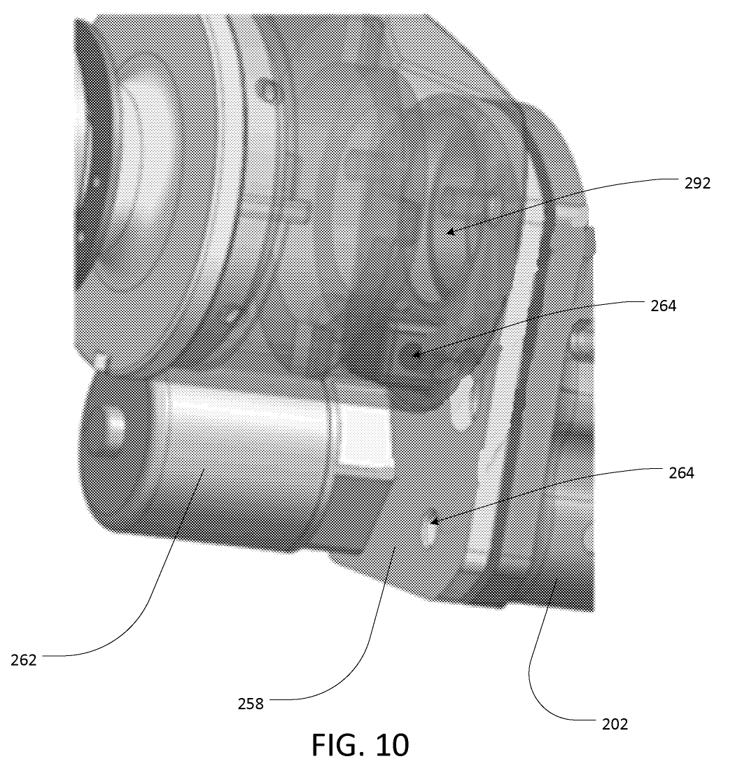

As shown in FIG. 10, the plurality of fasteners 264 are spaced about the clamping interface 258 such that tightening of the plurality of fasteners 264 generates an axial clamping force (parallel with the extension axis of the ram 182). This axial clamping force compresses together the reservoir 174, the clamping interface 258, the first bearing flange 230, and the gearbox 262 to form a fluid-tight seal. In some examples, the axial clamping force generated by the fasteners 264 secures sealing features of the reservoir 174 into corresponding grooves defined between the pump body 202 and the manifold 204 or the adapter plate 288. For example, as the fasteners 264 are tightened, the first protrusion 330 of the reservoir 174 is compressed into the first groove 280 of the pump body 202, creating an interlocking seal that resists fluid migration. In some examples, the clamping force distributes uniformly across the sealing interface, ensuring that the sealing features of the reservoir 174 are fully seated within the corresponding grooves to maintain seal integrity under operating pressures.

In some examples, sealing elements of a reservoir can be formed from non-rigid materials to facilitate sealing engagement with adjacent components. Non-rigid sealing elements can be arranged in different ways, such as a front face formed from an elastomeric material that deforms under compression, or a collar formed from a flexible material that creates an interference fit. For example, as shown in FIG. 8, the front face 222 of the reservoir 174 is a non-rigid material (e.g., rubber, plastic, nylon, elastomeric compound, etc.). Upon application of a compressive force by the pump body 202, the front face 222 elastically deforms to form a seal between the pump body 202 and the front face 222. Similarly, as the manifold 204 applies a compressive force to the front face 222, the front face 222 elastically deforms to form a seal between the manifold 204 and the front face 222. The elastic deformation of the front face 222 may provide enhanced sealing performance by conforming to surface irregularities of the pump body 202 and the manifold 204.

In some examples, deformation of a sealing element can be controlled or limited to ensure proper sealing and compression. Deformation control can be arranged in different ways, such as one of the pump body and the manifold extending through an opening in the reservoir to contact one another, or by providing contact surfaces that limit compression of the sealing element to a predetermined amount. For example, as shown in FIG. 8, the material and geometry of the front face 222 permit sealing engagement with both the pump body 202 and the manifold 204 while also permitting the pump body 202 and the manifold 204 to contact one another at an interface 250. The interface 250 is one of a plurality of interfaces between the pump body 202 and the manifold 204. The location of the interface 250 is selected to control an amount of deformation of the front face 222 along an axis 254 under sealing conditions.

The interface 250 between the manifold 204 and the pump body 202 enables more precise control of compression while maintaining sealing integrity. In some examples, the interface 250 functions as a mechanical stop that limits compression of the front face 222 to a predetermined amount, preventing over-compression that could damage the sealing element or cause extrusion of seal material. The mechanical stop provided by the interface 250 may ensure consistent seal performance across manufacturing tolerances by establishing a fixed compression distance regardless of variations in component dimensions. In some examples, the interface 250 improves assembly repeatability by providing a positive indication that the pump body 202 and the manifold 204 are properly seated relative to one another. The controlled compression may also reduce variability in sealing force, which contributes to more predictable seal behavior over the service life of the power tool.

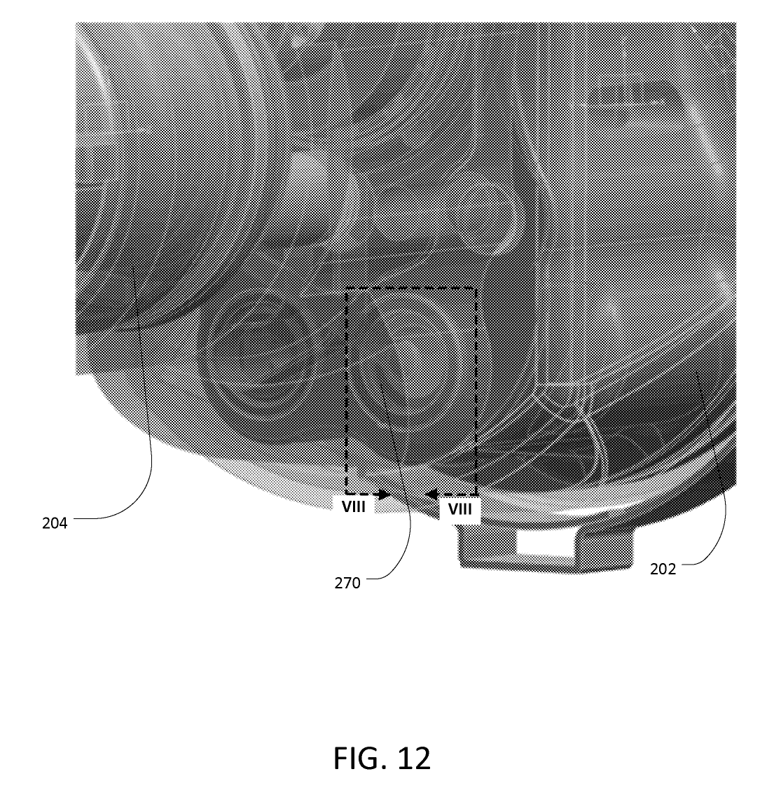

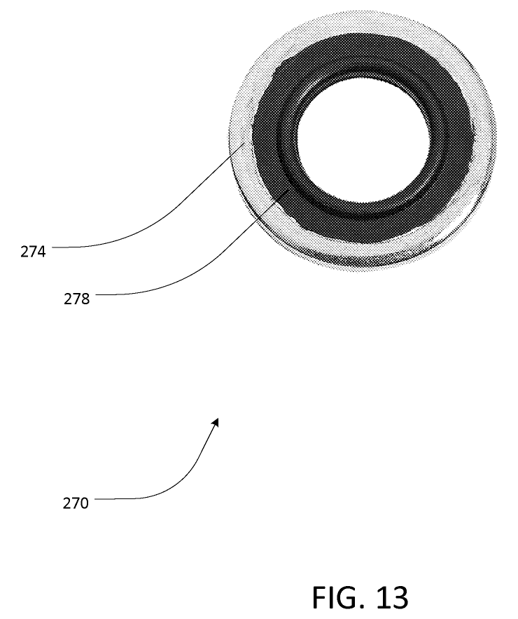

In some examples, a reservoir can include multiple materials with integrated sealing elements to provide improved sealing performance at the interface between the pump body and the manifold. A multimaterial reservoir can be arranged in different ways, such as a flexible outer material for the body of the reservoir combined with a rigid or semi-rigid material at the front face that includes additional sealing features, or as a reservoir with integrated gasket elements formed from different materials at sealing interfaces. For example, as shown in FIGS. 12-13, the interface between the pump body 202 and the manifold 204 is facilitated by a face sealing gasket 270. The face sealing gasket 270 is retained by the pump body 202. In some examples, the face sealing gasket 270 is retained by the manifold 204. The face sealing gasket 270 is positioned at the interface between the pump body 202 and the manifold 204 in place of, or in combination with, the front face 222 of the reservoir 174. The face sealing gasket 270 integrates a primary reservoir sealing function with a secondary high-pressure face sealing function at the pump outlet region.

In some examples, a face sealing gasket can be configured as a crush gasket to provide controlled deformation under compressive load. A crush gasket can be formed from different materials, such as plastic, metal, or a combination of rigid and compliant materials that deform predictably when compressed between mating surfaces. For example, as shown in FIG. 13, the face sealing gasket 270 is configured as a multi-material crush gasket including a rigid outer diameter 274 and a compliant inner diameter 278. The rigid outer diameter 274 provides structural support and maintains the overall shape of the face sealing gasket 270 during assembly and operation. The compliant inner diameter 278 deforms under compressive load to conform to mating surfaces of the pump body 202 and the manifold 204 to form a fluid-tight seal. The multi-material configuration may provide enhanced sealing performance by combining the dimensional stability of the rigid outer diameter 274 with the conformability of the compliant inner diameter 278.

In some examples, sealing elements can include integrated O-rings to provide additional sealing capability at critical interfaces. An integrated O-ring can be arranged in different ways, such as an O-ring formed integrally with the reservoir material at the front face, or an O-ring incorporated into a crush gasket at the interface between the pump body and the manifold. For example, the face sealing gasket 270 can include an integrated O-ring positioned at the compliant inner diameter 278 to provide a secondary seal at the pump outlet region. In some examples, the integrated O-ring is formed from an elastomeric material that is overmolded or bonded to the rigid outer diameter 274 of the face sealing gasket 270. The integrated O-ring may provide enhanced high-pressure sealing capability by creating a dedicated sealing zone that compresses against mating surfaces of the pump body 202 and the manifold 204. In some examples, the integrated O-ring configuration reduces component count by eliminating the need for a separate O-ring seal at the pump outlet interface.

The above discussion is presented to enable a person skilled in the art to make and use embodiments of the invention. Given the benefit of this disclosure, various modifications to the illustrated embodiments will be readily apparent to those skilled in the art, and the principles herein can be applied to other embodiments and applications without departing from embodiments of the invention. Thus, embodiments of the invention are not intended to be limited to embodiments shown, but are to be accorded the widest scope consistent with the principles and features disclosed herein.

The above detailed description is to be read with reference to the figures, in which like elements in different figures have like reference numerals. The figures, which are not necessarily to scale, depict selected embodiments and are not intended to limit the scope of embodiments of the invention. Skilled artisans will recognize the examples provided herein have many useful alternatives and fall within the scope of embodiments of the invention.

It is to be understood that the invention is not limited in its application to the details of construction and the arrangement of components set forth in the above description or illustrated in the drawings. The invention is capable of other embodiments and of being practiced or of being carried out in various ways. Also, it is to be understood that the phraseology and terminology used herein is for the purpose of description and should not be regarded as limiting. The use of “including,” “comprising,” or “having” and variations thereof herein is meant to encompass the items listed thereafter and equivalents thereof as well as additional items. Unless specified or limited otherwise, the terms “mounted,” “connected,” “supported,” and “coupled” and variations thereof are used broadly and encompass both direct and indirect mountings, connections, supports, and couplings. Further, “connected” and “coupled” are not restricted to physical or mechanical connections or couplings.

As also used herein, unless otherwise defined or limited, ordinal numbers are used herein for convenience of reference based generally on the order in which particular components are presented for the relevant part of the disclosure. In this regard, for example, designations such as “first,” “second,” etc., generally indicate only the order in which the relevant component is introduced for discussion and generally do not indicate or require a particular spatial arrangement, functional or structural primacy or order.

We claim:

1. A power tool comprising:
a motor;
a hydraulic actuator;
a pump operated by the motor to supply a fluid to the hydraulic actuator and positioned between the motor and the hydraulic actuator; and
a reservoir disposed over the pump, the reservoir including a collar at a first end coupled to a first bearing flange of the pump and a front face at a second end clamped between a second bearing flange of the pump and a manifold of the hydraulic actuator, wherein the reservoir is clamped at both the first end and the second end to seal the pump within the reservoir.

2. The power tool of claim 1, further comprising a clamping interface positioned between the reservoir, the pump, and a gearbox of the motor, the clamping interface configured to compress the collar against the first bearing flange.

3. The power tool of claim 2, wherein the clamping interface is a rigid plate defining a plurality of openings configured to receive fasteners that secure the clamping interface to the gearbox.

4. The power tool of claim 1, wherein the pump defines a first groove configured to receive a first protrusion of the reservoir.

5. The power tool of claim 4, wherein the pump defines a second groove configured to receive a second protrusion of the reservoir.

6. The power tool of claim 1, further comprising an adapter plate positioned between the pump and the second end of the reservoir, the adapter plate defining a groove configured to receive a protrusion of the reservoir.

7. The power tool of claim 1, wherein the front face is formed from a non-rigid material that elastically deforms under compression to form a seal between the pump and the manifold.

8. The power tool of claim 7, wherein the pump and the manifold contact one another at an interface that limits compression of the front face to a predetermined amount.

9. The power tool of claim 1, further comprising a face sealing gasket positioned at an interface between the pump and the manifold.

10. The power tool of claim 9, wherein the face sealing gasket is a multi-material crush gasket including a rigid outer diameter and a compliant inner diameter.

11. The power tool of claim 10, wherein the face sealing gasket includes an integrated O-ring at the compliant inner diameter.

12. A bladder assembly for a hydraulic power tool, the bladder assembly comprising:
a flexible body configured to contain hydraulic fluid and to be disposed about a pump body of the hydraulic power tool;
a collar at a first end of the flexible body, the collar defining a first end opening sized to receive the pump body and configured to be clamped between the pump body and a gearbox to form a first seal; and
a front face at a second end of the flexible body opposite the first end, the front face configured to be clamped between the pump body and a manifold of a hydraulic actuator to form a second seal, the front face including a first protrusion configured to be received in a first groove defined in the pump body or the manifold.

13. The bladder assembly of claim 12, wherein the front face includes a second protrusion configured to be received in a second groove defined in the pump body or the manifold.

14. The bladder assembly of claim 12, wherein the front face is formed from a non-rigid material configured to elastically deform under compression.

15. The bladder assembly of claim 12, further comprising a face sealing gasket integrated with the front face, the face sealing gasket including a rigid outer diameter and a compliant inner diameter.

16. The bladder assembly of claim 15, wherein the face sealing gasket includes an integrated O-ring.

17. A method of assembling a power tool, the method comprising:
inserting a pump body through a first end opening of a reservoir so that the pump body is disposed within the reservoir;
clamping a collar of the reservoir between a first bearing flange of the pump body and a gearbox to form a first seal; and
clamping a front face of the reservoir between a second bearing flange of the pump body and a manifold of a hydraulic actuator to form a second seal, wherein the pump body is sealed within the reservoir by the first seal and the second seal.

18. The method of claim 17, further comprising positioning a clamping interface between the reservoir and the gearbox, and securing the clamping interface to the gearbox with fasteners to generate an axial clamping force that compresses the collar against the first bearing flange.

19. The method of claim 17, wherein clamping the front face includes compressing a protrusion of the reservoir into a groove defined in the pump body or the manifold.

20. The method of claim 17, further comprising positioning a face sealing gasket at an interface between the pump body and the manifold, the face sealing gasket including a rigid outer diameter and a compliant inner diameter that deforms under compression to form a fluid-tight seal.
